(19) United States
(12) Patent Application Publication
(10) Pub. No.: US 2011/0291705 A1
(43) Pub. Date: Dec. 1, 2011

(54) ELECTRONIC EQUIPMENT AND POWER SUPPLY CONTROL METHOD

(75) Inventor: Yoichi Fukami, Osaka (JP)

(73) Assignee: SANYO Electric Co., Ltd., Osaka (JP)

(21) Appl. No.: 13/086,622

(22) Filed: Apr. 14, 2011

(30) Foreign Application Priority Data
May 26, 2010 (JP) 2010-120897

(51) Int. Cl. G05F 1/66

(52) U.S. Cl. 327/80

(57) ABSTRACT

Electronic equipment includes a battery, an interface portion to which a recording medium can be attached, a kind detection portion for detecting the kind of a recording medium, an access processing portion for executing a predetermined access process to a recording medium, a current consumption detection portion for detecting a value of current consumed by execution of the predetermined access process to the recording medium, an additional storage portion for storing a current consumption value corresponding to the detected kind into a storage portion, a power supply circuit for taking out and outputting electric power from the battery, and a power supply control portion for controlling the power supply circuit. The power supply control portion varies control on the power supply circuit in accordance with the current consumption value stored corresponding to the detected kind.

This application is based on Japanese Patent Application No. 2010-120897 filed with Japan Patent Office on May 26, 2010, the entire content of which is hereby incorporated by reference.

### BACKGROUND OF THE INVENTION

1. Field of the Invention

The present invention relates to electronic equipment and a power supply control method. More specifically, the present invention relates to electronic equipment driven by a battery and a power supply control method executed in the electronic equipment.

2. Description of the Related Art

Conventionally, in electronic recorders, it is contemplated that the remaining battery level is compared with a threshold value, whenever necessary, and when the remaining level is equal to or lower than the threshold value, the users are warned that the remaining level is low. The threshold value used in this comparison process may be set so as to guarantee the maximum current consumption value, which is the maximum value of current that may be consumed by, for example, access to different kinds of memory cards.

However, if a memory card having a current consumption value larger than the guaranteed maximum current consumption value is attached, it is not determined that the remaining level is low, because the comparison result shows the remaining level is equal to or higher than the threshold value. Accordingly, the access to the memory card causes unexpected large current to flow and rapidly decreases the battery remaining level, and as a result, the operation may be stopped abruptly.

### SUMMARY OF THE INVENTION

Electronic equipment driven by electric power from a battery includes: a storage portion to store a current consumption value corresponding to each kind of recording medium; an interface portion to which a recording medium can be attached; a kind detection portion to detect the kind of a recording medium attached to the interface portion; an access processing portion to execute a predetermined access process to the recording medium attached to the interface portion, if a current consumption value corresponding to the kind detected by the kind detection portion is not stored; a current detection portion to detect a value of current consumed by execution of the predetermined access process to the recording medium; a storage control portion to store a current consumption value corresponding to the kind detected by the kind detection portion, into the storage portion, based on the value of current detected by the current detection portion; a power supply circuit to take out and output electric power from the battery; and a power supply control portion to control the power supply circuit. The power supply control portion varies control on the power supply circuit in accordance with the current consumption value stored corresponding to the kind detected by the kind detection portion.

In accordance with another aspect of the present invention, electronic equipment driven by electric power from a battery includes: a storage portion to store a current consumption value corresponding to each kind of recording medium; an interface portion to which a recording medium can be attached; a kind detection portion to detect the kind of a recording medium attached to the interface portion; an access processing portion to execute a predetermined access process to the recording medium attached to the interface portion, if a current consumption value corresponding to the kind detected by the kind detection portion is not stored; a current detection portion to detect a value of current consumed by execution of the predetermined access process to the recording medium; a storage control portion to store a current consumption value corresponding to the kind detected by the kind detection portion, into the storage portion, based on the value of current detected by the current detection portion; and a warning portion to give a warning if the current consumption value stored corresponding to the kind detected by the kind detection portion is equal to or greater than a prescribed threshold value.

In accordance with a further aspect of the present invention, a power supply control method is executed in electronic equipment driven by electric power from a battery. The electronic equipment includes a storage portion to store a current consumption value corresponding to each kind of recording medium, an interface portion to which a recording medium can be attached, and a power supply circuit to take out and output electric power from the battery. The method includes: a step of detecting the kind of a recording medium attached to the interface portion; a step of executing a predetermined access process to the recording medium attached to the interface portion, if a current consumption value corresponding to the kind detected in the step of detecting the kind is not stored in the storage portion; a step of detecting a value of current consumed by execution of the predetermined access process to the recording medium; a step of storing the current consumption value corresponding to the kind detected in the step of detecting the kind, into the storage portion, based on the value of current detected in the step of detecting a value of current; and a control step of varying control on the power supply circuit in accordance with the current consumption value stored in the storage portion corresponding to the kind detected in the step of detecting the kind.

In accordance with yet another aspect of the present invention, a power supply control method is executed in electronic equipment driven by electric power from a battery. The electronic equipment includes a storage portion to store a current consumption value corresponding to each kind of recording medium, and an interface portion to which a recording medium can be attached. The method includes the steps of detecting the kind of a recording medium attached to the interface portion; executing a predetermined access process to the recording medium attached to the interface portion, if a current consumption value corresponding to the kind detected in the step of detecting the kind is not stored in the storage portion; detecting a value of current consumed by execution of the predetermined access process to the recording medium; storing a current consumption value corresponding to the kind detected in the step of detecting the kind, into the storage portion, based on the value of current detected in the step of detecting a value of current; and giving a warning if the current consumption value stored in the storage portion corresponding to the kind detected in the step of detecting the kind is equal to or greater than a prescribed threshold value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of an IC recorder.

FIG. 2 is a functional block diagram showing an overall hardware configuration of the IC recorder.

FIG. 3 is a functional block diagram showing an overall function of CPU together with data stored in EEPROM.

FIG. 4 is a flowchart showing an exemplary flow of a power supply control process.

FIG. 5 is a flowchart showing an exemplary flow of an available time display process.

FIG. 6 is a diagram showing an example of a capacity table.

FIG. 7 is a flowchart showing an exemplary flow of a low battery process.

### DESCRIPTION OF THE PREFERRED EMBODIMENTS

In the following, an IC recorder according to an embodiment of the present invention will be described. The IC recorder is an example of electronic equipment. It is noted that although an IC recorder is described as an example of electronic equipment, the electronic equipment may be a digital camera, a video camera, a mobile phone, a notebook computer, or the like as long as it is driven by a battery. In the following description, the same parts are denoted with the same reference signs. Their designations and functions are also the same. Therefore, a detailed description thereof will not be repeated.

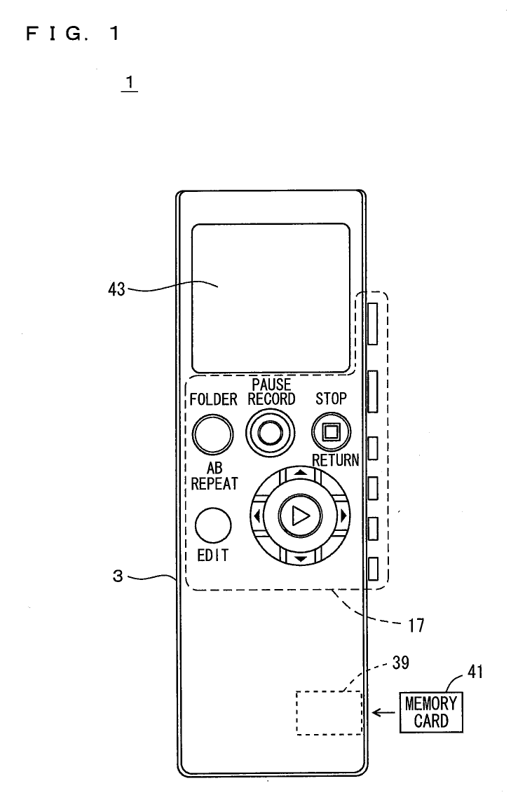

FIG. 1 is a plan view of an IC recorder. An IC recorder 1 includes a body unit 3, a liquid crystal display (LCD) 43 arranged on the front surface of body unit 3, an operation unit 17 including a plurality of buttons arranged on the front surface and the side surface of body unit 3, and a built-in memory I/F 39. The user can manipulate operation unit 17 while looking at a guide screen displayed on LCD 43. It is noted that LCD 43 may be replaced by any other display such as an organic ELD (Electro Luminescence Display). A memory card 41 can be attached to and removed from memory I/F 39. The dotted lines and the arrow in the figure are shown only for the sake of explanation and actually do not exist.

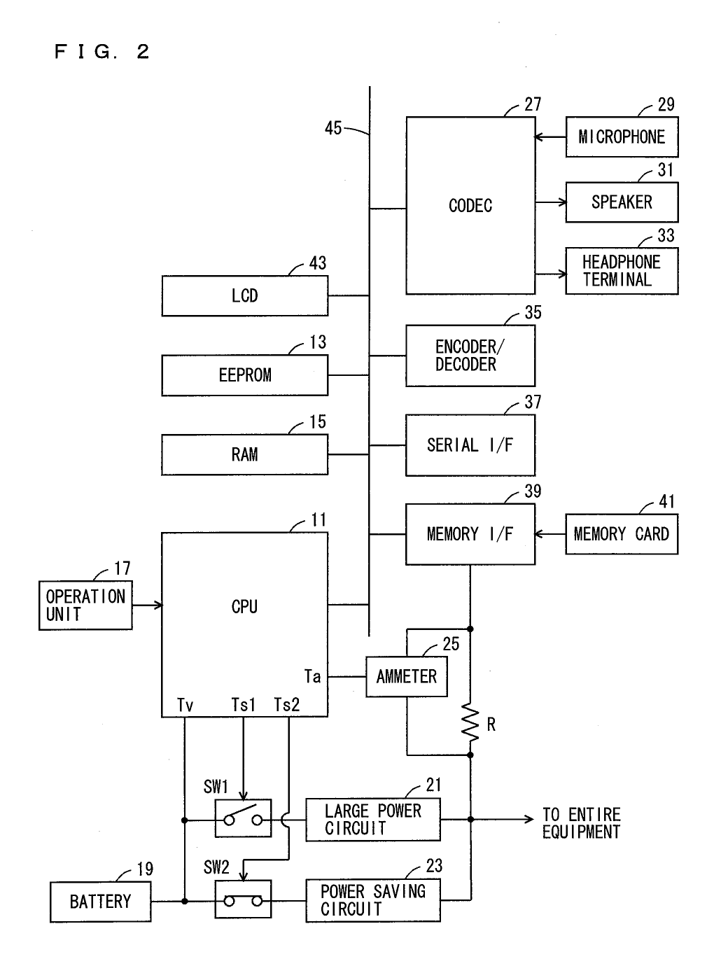

FIG. 2 is a functional block diagram showing an overall hardware configuration of the IC recorder. IC recorder 1 includes a CPU (Central Processing Unit) 11 for controlling the entire IC recorder, an EEPROM (Electrically Erasable and Programmable Read Only Memory) 13 for storing, for example, a program executed by CPU 11, LCD 43, a RAM (Random Access Memory) 15 used as a working area of CPU 11, operation unit 17 accepting the operation by the user, a codec 27, a microphone 29, a speaker 31, a headphone terminal 33, an ammeter 25, a resistor R, switches SW1, SW2, an encoder/decoder 35, a serial interface (I/F) 37, a memory interface (I/F) 39, a battery 19, a larger power circuit 21, and a power saving circuit 23.

CPU 11, EEPROM 13, RAM 15, codec 27, encoder/decoder 35, serial I/F 37, memory I/F 39, and LCD 43 are connected through a bus 45 so that data can be sent to and received from each other.

RAM 15 is used as a working area of CPU 11. EEPROM 13 stores a program executed by CPU 11, a parameter for executing the program, master data as described later, and so on, as well as a compressed audio signal, in a nonvolatile manner. Different kinds of memory cards 41 can be attached to memory I/F 39. The kind of memory card 41 varies depending on the standard, and even if the standard is the same, varies depending on the manufacturer or the storage capacity.

Microphone 29, speaker 31, and headphone terminal 33 are connected to codec 27. Codec 27 receives an analog audio signal from microphone 29 and outputs an analog audio signal to speaker 31 and headphone terminal 33.

Encoder/decoder 35 is controlled by CPU 11 to encode the audio signal output from codec 27 and generate sound data. Encoder/decoder 35 is also controlled by CPU 11 to decode sound data and generate an audio signal.

CPU 11 allows encoder/decoder 35 to encode the audio signal output from codec 27 and stores the encoded sound data into EEPROM 13 or memory card 41 connected to memory I/F 39.

CPU 11 also reads out the sound data stored in EEPROM 13 or memory card 41 connected to memory I/F 39 to allow encoder/decoder 35 to decode the read sound data and to allow codec 27 to convert the decoded audio signal into an analog signal, and outputs the analog audio signal to speaker 31 or the headphone connected to headphone terminal 33.

Serial I/F 37 is connected to a device capable of serial communication. CPU 11 can communicate with a device connected to serial I/F 37 via serial I/F 37.

Battery 19 is a primary battery such as a manganese battery or a lithium battery, or a secondary battery such as a lithium ion battery, a nickel-metal hydride battery, or a nickel cadmium battery. Battery 19 may be either a primary battery or a secondary battery. Battery 19 has an output terminal connected to a terminal Tv of CPU 11, so that CPU 11 detects a voltage at terminal Tv as an output voltage of battery 19.

Large power circuit 21 and power saving circuit 23 are power supply circuits which control voltage and current of electric power output from battery 19 such that they are kept constant. Output voltage from large power circuit 21 is equal to that of power saving circuit 23, whereas current that can be output by large power circuit 21 is larger than that of power saving circuit 23. Power consumption of large power circuit 21 is larger than that of power saving circuit 23.

Large power circuit 21 has an input side connected to battery 19 through switch SW1 and an output side connected to each component of the equipment including CPU 11 as a whole. Switch SW1 is connected to a terminal Ts1 of CPU 11 and controlled by CPU 11. When switch SW1 is closed, large power circuit 21 is connected with battery 19. When switch SW1 is open, the connection between large power circuit 21 and battery 19 is cut off.

Power saving circuit 23 has an input side connected to battery 19 through switch SW2 and has an output side connected to each component of the equipment including CPU 11 as a whole. Switch SW2 is connected to a terminal Ts2 of CPU 11 and controlled by CPU 11. When switch SW2 is closed, power saving circuit 23 is connected with battery 19. When switch SW2 is open, the connection between power saving circuit 23 and battery 19 is cut off.

CPU 11 opens either one of switches SW1 and SW2 and closes the other. Therefore, each component of IC recorder 1 is supplied with power stored in battery 19 from either one of large power circuit 21 and power saving circuit 23.

The output side of large power circuit 21 and the output side of power saving circuit 23 are connected to each component of IC recorder 1. In FIG. 2, only the connection to the power supply input terminal of memory I/F 39 is shown for the sake of illustration. The output side of large power circuit 21 and the output side of power saving circuit 23 are connected to the power supply input terminal of memory I/F 39 through resistor R. Ammeter 25 is connected in parallel with resistor R. Ammeter 25 is connected to a terminal Ta of CPU 11 and controlled by CPU 11. Ammeter 25 outputs to CPU 11 a value of current flowing through resistor R. Preferably, resistor R has a resistance value as smallest as possible.

Although, here, CPU 11 executes a power supply control program stored in EEPROM 13, by way of example, the power supply control program executed by CPU 11 may be stored in memory card 41. A recording medium for storing the power supply control program is not limited to memory card 41 and may be an optical disk (CD-ROM (Compact Disk Read Only Memory), MO (Magnetic Optical Disc)/MD (Mini Disc)/DVD (Digital Versatile Disc), an optical card, or a semiconductor memory such as a mask ROM or an EPROM (Erasable Programmable ROM).

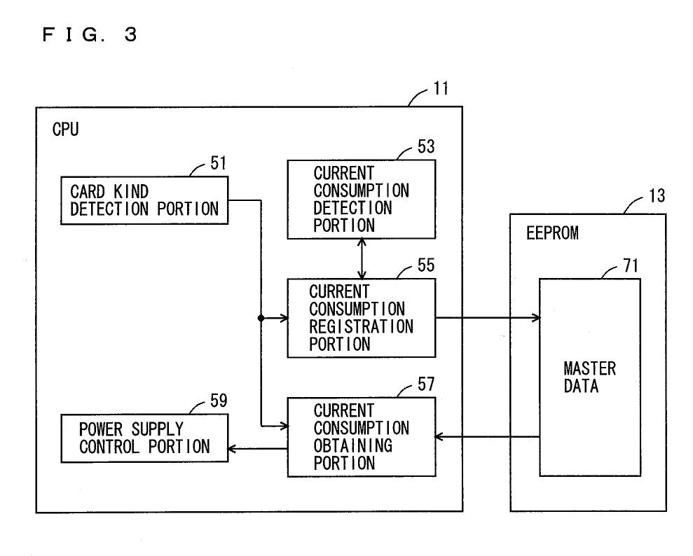

FIG. 3 is a functional block diagram showing the overall function of CPU together with data stored in EEPROM 13. EEPROM 13 stores master data 71. Master data 71 includes a master record which associates the kind of memory card with a current consumption value. Master data 71 includes the same number of master records as the number of kinds of memory cards. Master data 71 includes memory records corresponding to the predetermined kinds of memory cards at the time of shipment of IC recorder 1.

CPU 11 includes a card kind detection portion 51 detecting the kind of a memory card attached to memory I/F 39, a current consumption detection portion 53 detecting current consumed by the memory card attached to memory I/F 39, a current consumption registration portion 55 generating and registering a master record in master data 71, a current consumption obtaining portion 57 obtaining a current consumption value of the memory card attached to memory I/F 39, and a power supply control portion 59 controlling large power circuit 21 and power saving circuit 23.

When receiving a notification from memory I/F 39 that memory card 41 is inserted, card kind detection portion 51 accesses memory card 41 through memory I/F 39 to read out the card kind stored in a predetermined region of memory card 41, for example, a register. The card kind is, for example, a device code or a manufacturer code. Card kind detection portion 51 outputs the card kind of memory card 41 attached to memory I/F 39 to current consumption registration portion 55 and current consumption obtaining portion 57.

When the card kind is input from card kind detection portion 51, current consumption registration portion 55 searches master data 71 stored in EEPROM 13 to determine whether the master record including the card kind is stored. If the master record is not stored, current consumption registration portion 55 outputs a detection instruction to current consumption detection portion 53.

Current consumption detection portion 53 executes a predetermined access process in response to input of the detection instruction. The access process is desirably such a process in that the load on memory card 41 is large and current consumption becomes large. The access process includes, for example, the process of writing test data stored beforehand in EEPROM 13 into memory card 41, the process of reading out the written data, and the process of erasing the written data. While executing the access process, current consumption detection portion 53 controls ammeter 25 such that current flowing through resistor R is measured. Current consumption detection portion 53 determines a current consumption value of memory card 41 based on the current value input from ammeter 25. The current consumption value of memory card 41 is, for example, the maximum value of current values for the time during which the access process is being executed. The current consumption value of memory card 41 may be the mean value of current values for the time during which the access process is being executed. Current consumption detection portion 53 outputs the current consumption value of memory card 41 to current consumption registration portion 55.

After outputting the detection instruction, current consumption registration portion 55 generates a master record that associates the current consumption value input from current consumption detection portion 53 with the kind of card input from card kind detection portion 51, and additionally stores the generated master record into master data 71 stored in EEPROM 13.

When the card kind is input from card kind detection portion 51, current consumption obtaining portion 57 searches master data 71 stored in EEPROM 13 and reads out the master record including the card kind. Then, current consumption obtaining portion 57 obtains the current consumption value associated with the card kind by the read master record, and outputs the obtained current consumption value to power supply control portion 59.

Power supply control portion 59 controls large power circuit 21 and power saving circuit 23. In a normal state, here, in a state in which memory card 41 is not connected to memory I/F 39, power supply control portion 59 opens first switch SW1 to cut off large power circuit 21 from battery 19 and closes second switch SW2 to connect power saving circuit 23 to battery 19. In other words, in the normal state, IC recorder 1 receives electric power stored in battery 19 from power saving circuit 23.

Power supply control circuit 59 compares the current consumption value input from current consumption obtaining portion 57 with a predetermined threshold value T, and if the current consumption value is equal to or greater than threshold value T, closes first switch SW1 to connect large power circuit 21 to battery 19 and opens second switch SW2 to cut off power saving circuit 23 from battery 19. Accordingly, electric power stored in battery 19 is output from large power circuit 21, so that current can flow throughout IC recorder 1 even when current consumed by memory card 41 is large and current consumed by IC recorder 1 is thus increased. Therefore, even when memory card 41 whose current consumption is large is attached to IC recorder 1, IC recorder 1 can continue to be operated.

On the other hand, if the current consumption value input from current consumption obtaining portion 57 is smaller than threshold value T, power supply control portion 59 opens first switch SW1 to cut off large power circuit 21 from battery 19 and closes second switch SW2 to connect power saving circuit 23 to battery 19, similarly to the normal state. This minimizes the power consumption.

Furthermore, power supply control portion 59 compares the current consumption value input from current consumption obtaining portion 57 with threshold value T and changes a termination voltage value based on the result of comparison. Power supply control portion 59 sets the termination voltage value in the normal state to a power-saving voltage EV1 stored beforehand in EEPROM 13. Output voltage V of battery 19 decreases as the storage capacity decreases. The termination voltage value is the output voltage of battery 19 at the time immediately before the storage capacity of battery 19 is so decreased that battery 19 cannot output electric power for driving IC recorder 1. If the current consumption value input from current consumption obtaining portion 57 is smaller than the threshold value, power supply control portion 59 sets the termination voltage value to power-saving voltage EV1. If the current consumption value input from current consumption obtaining portion 57 is equal to or greater than the threshold value, power supply control portion 59 sets the termination voltage value to a large-power voltage EV2 greater than power-saving voltage EV1. Large-power voltage EV2 may be stored beforehand in EEPROM 13 or may be calculated based on the current consumption value input from current consumption obtaining portion 57.

Power supply control portion 59 detects output voltage V of battery 19 at terminal Tv, and, when the detected output voltage V is equal to or lower than the termination voltage value, opens first switch SW1 and second switch SW2 so that large power circuit 21 and power saving circuit 23 are not connected with battery 19. Accordingly, IC recorder 1 can be stopped before the storage capacity of battery 19 is so decreased that battery 19 cannot output electric power for driving IC recorder 1. It is noted that power supply control portion 59 may display a message like, for example, “please replace the battery” on LCD 43 before opening first switch SW1 and second switch SW2. Accordingly, the user can be notified that battery 19 becomes exhausted and the storage capacity is low.

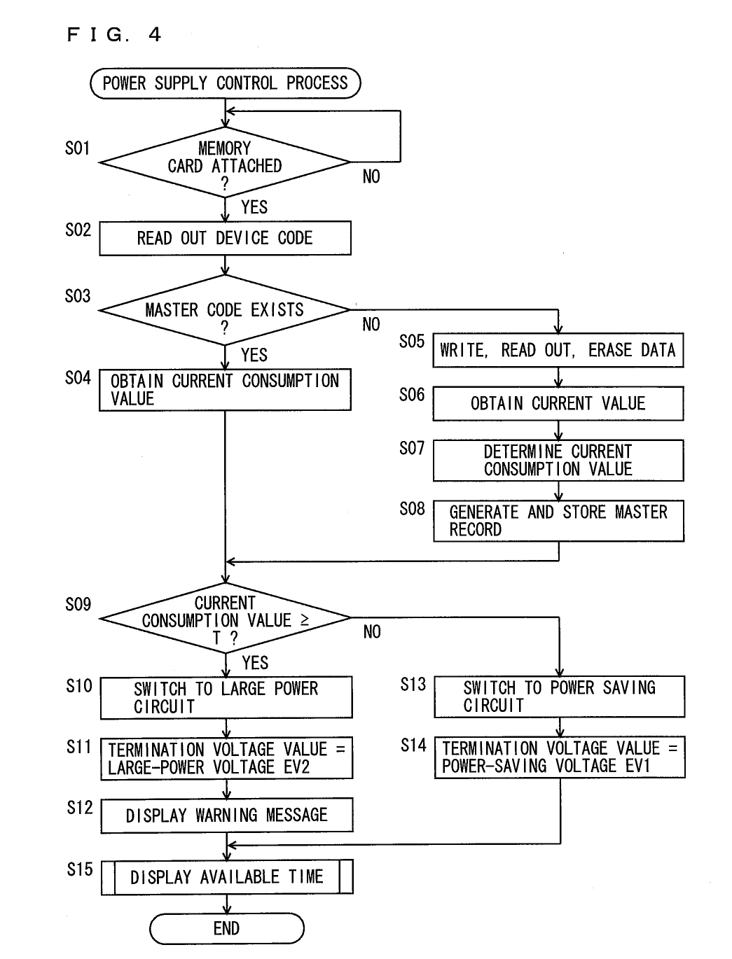

FIG. 4 is a flowchart showing an exemplary flow of a power supply control process. The power supply control process is a process executed by CPU 11 executing the power supply control program stored in EEPROM 13. CPU 11 determines whether a memory card is attached to memory I/F 39. When memory card 41 is attached, memory I/F 39 outputs a signal to CPU 11 to indicate that memory card 41 is attached. Thus, CPU 11 detects the signal thereby to detect that memory card 41 is attached. The process waits until memory card 41 is attached (NO in step S01). If memory card 41 is attached (YES in step S01), the process proceeds to step S02.

In step S02, CPU 11 accesses memory card 41 through memory I/F 39 to read out a device code stored in a register of memory card 41. Then, it is determined whether the master record including the device code exists. Specifically, CPU 11 searches master data 71 stored in EEPROM 13 to determine whether the master record including the device code is stored in master data 71. If the master record exists, the process proceeds to step S04, and if not, the process proceeds to step S05.

In step S04, CPU 11 obtains the current consumption value set in the master record read out in step S03, and the process then proceeds to step S09. On the other hand, in step S05, CPU 11 accesses memory card 41 through memory I/F 39 to write test data stored beforehand in EEPROM 13, read out the written test data, and erase the written test data. In the meantime, CPU 11 obtains a current value output by ammeter 25 (step S06). In step S06, current values are continuously obtained until the writing, reading-out, and erasing of test data is completed. In other words, CPU 11 obtains current values measured by ammeter 25 while writing, reading out, and erasing test data in memory card 41.

In step S07, a current consumption value is determined. The maximum value of the current values obtained in step S06 is determined as a current consumption value. In the next step S08, a master record is generated, which includes the device code read out in step S02 and the current consumption value determined in step S07, and the generated master record is additionally stored into master data 71 stored in EEPROM 13. Then, the process proceeds to step S09.

In step S09, the current consumption value is compared with threshold value T. If the process proceeds from step S04, the current consumption value obtained in step S04 is compared with threshold value T. If the process proceeds from step S08, the current consumption value determined in step S07 is compared with threshold value T. If the current consumption value is equal to or greater than threshold value T, the process proceeds to step S10. If not, the process proceeds to step S13.

In step S10, switching to large power circuit 21 takes place, and the process then proceeds to step S11. Specifically, first switch SW1 is closed to connect large power circuit 21 to battery 19, and second switch SW2 is opened to cut off power saving circuit 23 from battery 19. In the next step S11, the termination voltage value is set to large-power voltage EV2, and the process then proceeds to step S12. In step S12, a warning message is displayed on LCD 43, and the process proceeds to step S15. An example of the warning message is “The current consumption of the memory card is too large. Please reduce the use time as much as possible.”

On the other hand, in step S13, switching to power saving circuit 23 takes place, and the process then proceeds to step S14. Specifically, first switch SW1 is opened to cut off large power circuit 21 from battery 19, and second switch SW2 is closed to connect power saving circuit 23 to battery 19. In the next step S14, the termination voltage value is set to power-saving voltage EV1, and the process then proceeds to step S15.

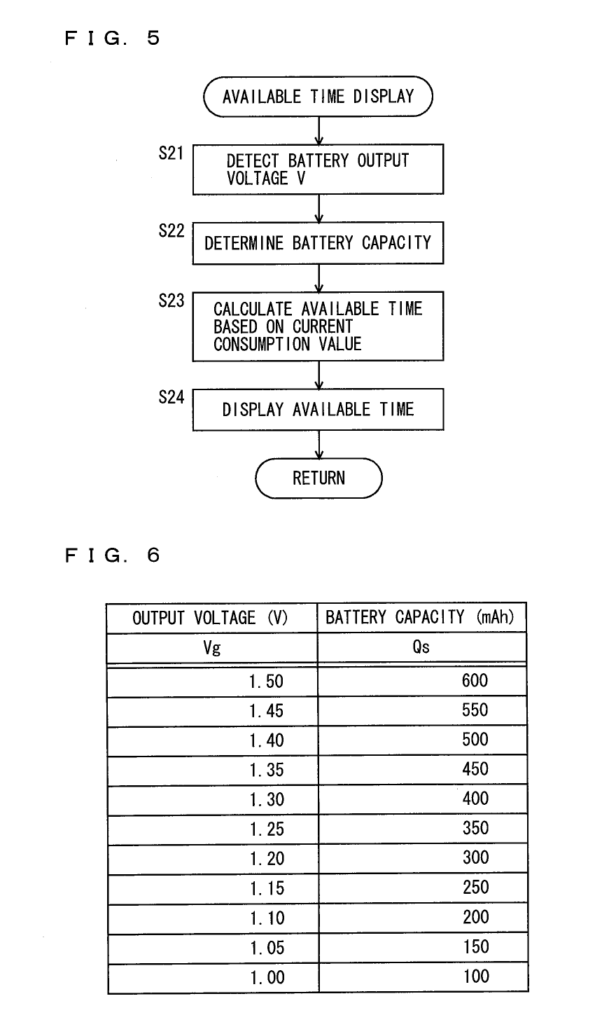

In step S15, an available time display process is executed, and the process then ends. FIG. 5 is a flowchart showing an exemplary flow of the available time display process. CPU 11 detects output voltage V of battery 19 by detecting the voltage at terminal Tv (step S21). In the next step S22, the battery capacity is determined. A capacity table is stored in EEPROM 13, in which the relation between output voltage V and battery capacity is defined beforehand. The capacity table is searched for the output voltage of battery 19 detected in step S21. The battery capacity is thus determined.

FIG. 6 is a diagram showing an example of the capacity table. The capacity table includes entries of output voltage V and entries of battery capacity Qs. The capacity table associates battery capacities Qs with output voltages Vg of battery 19. For example, when output voltage Vg is 1.5 V, battery capacity Qs is 600 mAh.

Returning to FIG. 5, in step S23, available time Ts is calculated using current consumption value Ia obtained or determined in step S04 or step S07 in FIG. 4, battery capacity Qs determined in step S22, and the following equation (1).

Ts(h)=Qs(B×(Ia+A)) (1)

Coefficient A is a value of current flowing through IC recorder 1 in the normal state of IC recorder 1 and is a predetermined value. Coefficient B is a conversion efficiency and is a predetermined value. In the next step S24, the calculated available time Ts is displayed on LCD 43, and the process returns to the power supply control process.

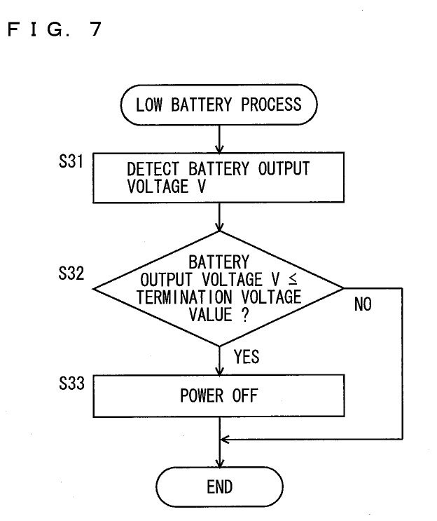

FIG. 7 is a flowchart showing an exemplary flow of a low battery process. The low battery process is a process executed by CPU 11 executing the power supply control program stored in EEPROM 13. CPU 11 detects output voltage V of battery 19 by detecting the voltage at terminal Tv (step S31). In the next step S32, the detected output voltage V of battery 19 is compared with the termination voltage value. If output voltage V is equal to or lower than the termination voltage value, the process proceeds to step S33. If not, the process skips step S33 and ends. The termination voltage value is a value set in step S11 or step S14 in FIG. 4. If the current consumption value of memory card 41 attached to memory I/F 39 is equal to or greater than threshold value T, the termination voltage value is set to large-power voltage EV2 in step S11. If the current consumption value of memory card 41 attached to memory I/F 39 is smaller than threshold value T, the termination voltage value is set to power-saving voltage EV1 in step S14. In step S33, the power is turned off, and the process then ends. Specifically, first switch SW1 and second switch SW2 are opened to cut off large power circuit 21 and power saving circuit 23 from battery 19.

Although the present embodiment includes large power circuit 21 and power saving circuit 23 by way of example, only power saving circuit 23 may be provided without large power circuit 21. In this case, power supply control portion 59 closes second switch SW2 to connect power saving circuit 23 to battery 19, if the current consumption value input from current consumption obtaining portion 57 is smaller than threshold value T, and power supply control portion 59 opens second switch SW2 to cut off power saving circuit 23 from battery 19, if the current consumption value input from current consumption obtaining portion 57 is equal to or greater than threshold value T. Accordingly, IC recorder 1 is not driven in a state in which memory card 41 whose current consumption value is equal to or greater than a prescribed threshold value is attached, thereby preventing IC recorder 1 from abruptly stopping due to the decreased storage capacity of battery 19.

As described above, the IC recorder in accordance with the present embodiment detects the kind of memory card 41 attached to memory I/F 39, and, if the current consumption value corresponding to the detected kind is not stored in master data 71, executes an access process of accessing memory card 41 to write, read out, and erase test data, and stores the current value detected by ammeter 25 during execution of the access process, as a new current consumption value corresponding to the kind of memory card 41, into master data 71. Therefore, if memory card 41 whose current consumption value is unknown is attached, its current consumption can be detected. In addition, the control of the power supply circuit differs depending on the difference of current consumption among the attached memory cards 41, so that the difference of current consumption among memory cards 41 can be handled by the power supply circuit.

Specifically, if the current consumption value stored corresponding to the kind of the attached memory card 41 is smaller than a prescribed threshold value, power saving circuit 23 is connected to battery 19, and if the current consumption value is equal to or greater than the prescribed threshold value, large power circuit 21 is connected to battery 19. This reduces the probability that the shortage of current supply from battery 19 occurs when memory card 41 whose current consumption is equal to or greater than the prescribed threshold value is attached.

Moreover, if the current consumption value of the attached memory card 41 is smaller than the prescribed threshold value, power saving circuit 23 is cut off from battery 19 when output voltage V of battery 19 becomes equal to or lower than power-saving termination voltage EV1. If the current consumption value of the attached memory card 41 is equal to or greater than the prescribed threshold value, large power circuit 21 is cut off from battery 19 when output voltage V of battery 19 becomes equal to or lower than large-current termination voltage EV2. The threshold value at which power saving circuit 23 and large power circuit 21 are cut off from battery 19 is changed depending on the current consumption value of memory card 41 attached to memory I/F 39. Therefore, IC recorder 1 can be powered off before battery 19 is exhausted and unable to output required current, even when memory card 41 is attached to cause a variation in the entire current consumption of IC recorder 1.

In the case where IC recorder 1 does not include large power circuit 21 and only includes power saving circuit 23, if the current consumption value of memory card 41 is smaller than threshold value T, power supply control portion 59 closes second switch SW2 to connect power saving circuit 23 to battery 19. However, if the current consumption value of memory card 41 that is input from current consumption obtaining portion 57 is equal to or greater than threshold value T, power supply control portion 59 opens second switch SW2 to cut off power saving circuit 23 from battery 19. Accordingly, in a state in which memory card 41 whose current consumption value is equal to or greater than prescribed threshold value T is attached, IC recorder 1 is not driven, thereby preventing IC recorder 1 from abruptly stopping due to the decreased storage capacity of battery 19.

Furthermore, if the current consumption value of memory card 41 that is input from current consumption obtaining portion 57 is equal to or greater than threshold value T, a warning message is displayed on LCD 43. An example of the warning message is “The current consumption of the memory card is too large. Please reduce the use time as much as possible.” Therefore, the user can be notified that the use of memory card 41 shortens the lifetime of battery 19.

Although IC recorder 1 has been described in the present embodiment, the present invention can be understood as a power supply control method for causing IC recorder 1 to execute the processes shown in FIG. 4, FIG. 5 and FIG. 7, or a power supply control program for causing CPU 11 which controls IC recorder 1 to execute the power supply control method, as a matter of course.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. Electronic equipment driven by electric power from a battery, comprising:
a storage portion to store a current consumption value corresponding to each kind of recording medium;
an interface portion to which a recording medium can be attached;
a kind detection portion to detect the kind of a recording medium attached to said interface portion;
an access processing portion to execute a predetermined access process to said recording medium attached to said interface portion, if a current consumption value corresponding to the kind detected by said kind detection portion is not stored;
a current detection portion to detect a value of current consumed by execution of said predetermined access process to said recording medium;
a storage control portion to store a current consumption value corresponding to the kind detected by said kind detection portion, into said storage portion, based on the value of current detected by said current detection portion;
a power supply circuit to take out and output electric power from said battery; and
a power supply control portion to control said power supply circuit,
wherein said power supply control portion varies control on said power supply circuit in accordance with the current consumption value stored corresponding to the kind detected by said kind detection portion.

2. The electronic equipment according to claim 1, wherein
said power supply circuit includes a first power supply circuit and a second power supply circuit capable of outputting current higher than that of said first power supply circuit, and
if the current consumption value stored corresponding to the kind detected by said kind detection portion is smaller than a prescribed threshold value, said power supply control portion connects said first power supply circuit to said battery, and if the current consumption value stored corresponding to the kind detected by said kind detection portion is equal to or greater than the prescribed threshold value, said power supply control portion connects said second power supply circuit to said battery.

3. The electronic equipment according to claim 1, further comprising an output voltage detection portion to detect an output voltage of said battery,
wherein if the current consumption value stored corresponding to the kind detected by said kind detection portion is smaller than a prescribed threshold value, said power supply control portion cuts off said power supply circuit when said detected output voltage becomes equal to or lower than a first termination voltage value, and if the current consumption value stored corresponding to the kind detected by said kind detection portion is equal to or greater than the prescribed threshold value, said power supply control portion cuts off said power supply circuit when said detected output voltage becomes equal to or lower than a second termination voltage value higher than said first termination voltage value.

4. The electronic equipment according to claim 1, wherein if the current consumption value stored corresponding to the kind detected by said kind detection portion is smaller than a prescribed threshold value, said power supply control portion allows said power supply circuit to continue to output electric power, and if the current consumption value stored corresponding to the kind detected by said kind detection portion is equal to or greater than the prescribed threshold value, said power supply control portion allows said power supply circuit to cut off output of electric power.

5. The electronic equipment according to claim 1, further comprising a warning portion to give a warning if the current consumption value stored corresponding to the kind detected by said kind detection portion is equal to or greater than a prescribed threshold value.

6. Electronic equipment driven by electric power from a battery, comprising:
a storage portion to store a current consumption value corresponding to each kind of recording medium;
an interface portion to which a recording medium can be attached;
a kind detection portion to detect the kind of a recording medium attached to said interface portion;
an access processing portion to execute a predetermined access process to said recording medium attached to said interface portion, if a current consumption value corresponding to the kind detected by said kind detection portion is not stored;
a current detection portion to detect a value of current consumed by execution of said predetermined access process to said recording medium;
a storage control portion to store a current consumption value corresponding to the kind detected by said kind detection portion, into said storage portion, based on the value of current detected by said current detection portion; and
a warning portion to give a warning if the current consumption value stored corresponding to the kind detected by said kind detection portion is equal to or greater than a prescribed threshold value.

7. A power supply control method executed in electronic equipment driven by electric power from a battery,
said electronic equipment including
a storage portion to store a current consumption value corresponding to each kind of recording medium,
an interface portion to which a recording medium can be attached, and
a power supply circuit to take out and output electric power from said battery,
said method comprising:
a step of detecting the kind of a recording medium attached to said interface portion;
a step of executing a predetermined access process to said recording medium attached to said interface portion, if a current consumption value corresponding to the kind detected in said step of detecting the kind is not stored in said storage portion;
a step of detecting a value of current consumed by execution of said predetermined access process to said recording medium;
a step of storing the current consumption value corresponding to the kind detected in said step of detecting the kind, into said storage portion, based on the value of current detected in said step of detecting a value of current; and
a control step of varying control on said power supply circuit in accordance with the current consumption value stored in said storage portion corresponding to the kind detected in said step of detecting the kind.

8. The power supply control method according to claim 7, wherein
said power supply circuit includes a first power supply circuit and a second power supply circuit capable of outputting current higher than that of said first power supply circuit, and
said control step includes the steps of:
if the current consumption value stored in said storage portion corresponding to the kind detected in said step of detecting the kind is smaller than a prescribed threshold value, connecting said first power supply circuit to said battery; and
if the current consumption value stored in said storage portion corresponding to the kind detected in said step of detecting the kind is equal to or greater than the prescribed threshold value, connecting said second power supply circuit to said battery.

9. The power supply control method according to claim 7, further comprising a step of detecting an output voltage of said battery,
wherein said control step further includes the steps of;
if the current consumption value stored in said storage portion corresponding to the kind detected in said step of detecting the kind is smaller than a prescribed threshold value, cutting off said power supply circuit when said detected output voltage becomes equal to or lower than a first termination voltage value; and
if the current consumption value stored in said storage portion corresponding to the kind detected in said step of detecting the kind is equal to or greater than the prescribed threshold value, cutting off said power supply circuit when said detected output voltage becomes equal to or lower than a second termination voltage value higher than said first termination voltage value.

10. The power supply control method according to claim 7, wherein said control step includes the steps of:
if the current consumption value stored in said storage portion corresponding to the kind detected in said step of detecting the kind is smaller than a prescribed threshold value, allowing said power supply circuit to continue to output electric power; and
if the current consumption value stored in said storage portion corresponding to the kind detected in said step of detecting the kind is equal to or greater than the prescribed threshold value, allowing said power supply circuit to cut off output of electric power.

11. The power supply control method according to claim 7, further comprising a step of giving a warning if the current consumption value stored in said storage portion corresponding to the kind detected in said step of detecting the kind is equal to or greater than a prescribed threshold value.

12. A power supply control method executed in electronic equipment driven by electric power from a battery,
said electronic equipment including
a storage portion to store a current consumption value corresponding to each kind of recording medium, and
an interface portion to which a recording medium can be attached,
said method comprising the steps of:
detecting the kind of a recording medium attached to said interface portion;
executing a predetermined access process to said recording medium attached to said interface portion, if a current consumption value corresponding to the kind detected in said step of detecting the kind is not stored in said storage portion;
detecting a value of current consumed by execution of said predetermined access process to said recording medium;
storing a current consumption value corresponding to the kind detected in said step of detecting the kind, into said storage portion, based on the value of current detected in said step of detecting a value of current; and
giving a warning if the current consumption value stored in said storage portion corresponding to the kind detected in said step of detecting the kind is equal to or greater than a prescribed threshold value.
